(19) United States
(12) Patent Application Publication
(10) Pub. No.: US 2006/0133891 A1
(43) Pub. Date: Jun. 22, 2006

(54) Ball joint seal

(76) Inventor: Dwayne Cook, Sterling Heights, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/018,326

(22) Filed: Dec. 21, 2004

(51) Int. Cl. F16D 1/12

(52) U.S. Cl. 403/134

(57) ABSTRACT

A ball joint is provided for interconnecting a first member of a vehicle to a second member of a vehicle. A housing coupled to a first member includes a cavity. A ball stud coupled to a second member includes a ball end portion received in the cavity and a shank portion extending from the ball end portion projecting from the cavity. A tubular wear member has an inner side surface and an exterior side surface. The inner side surface is sealingly disposed on a portion of the shank portion. An annular seal includes a first end seal portion sealingly engaging the housing around the cavity and a second end seal portion for sealingly engaging the exterior side surface of the tubular wear member. The tubular wear member maintains a seal between the shank portion and the second end seal portion and reduces wear of the annular seal as the ball stud pivots within the cavity.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

This invention relates in general to a ball joint, and more specifically, to a ball joint for reducing the wear of a seal encapsulating the ball joint.

2. Description of the Related Art

A ball joint connection typically includes a ball stud and a socket that are pivotably connected. The ball stud includes a ball end and a shank. A portion of the ball end is received in the socket while a portion of the shank projects outwardly from the socket. The ball stud is pivotable within the socket. The socket and ball stud joint is typically filled with grease or other similar substance to lubricate the joint. A seal which typically includes two opposed apertures, encapsulates the socket and a portion of the ball joint ball stud. The seal maintains lubricant within the seal and prevents dirt and other contaminants from entering the ball joint, which may prevent premature wear of the joint. A housing encasing the socket is coupled to a first vehicle member while the ball stud is connected to a second vehicle member.

Ball joints are commonly used in suspensions systems and steering systems. As the vehicle is subjected to various forces (e.g., unlevel terrain, pot holes, or vehicle turns) the ball stud pivots within the socket which allows the vehicle members coupled to the ball joint to move in various directions with respect to one another. As the ball stud pivots within the socket, an end portion of the seal (i.e., portion of the seal engaging a portion of the ball stud) moves along the metal shank of the ball stud. The constant displacement of the end portion of the seal against the metal shank results in frictional wear of the seal. As the seal becomes worn from the repetitious movement of the end portion of the seal against the metal shank, lubricant in the seal may leak from the ball joint thereby dissipating the lubricant in the ball joint. Furthermore, contaminant (e.g., dirt, debris, or road salt) may enter the ball joint which may inhibit the movement of the ball stud or cause premature wear of the ball joint.

Metallic paint finishes have been applied to the contacting area of the ball studs for reducing wear of the seal. Such coatings are primarily used for exterior surface corrosion resistance. The metal-based finish still results in an abrasive surface. Such coatings typically require that the surface to which the coating will be applied is cleaned by an alkaline wash or spray for adhesion purposes. Furthermore, the parts may also require scouring or roughing the surface to provide for good adhesion to the treated surface. Added processes such as the cleaning wash or roughing of the exterior surface add complexity, cost, and is time consuming to the manufacturing process.

### SUMMARY OF THE INVENTION

The present invention has the advantage of reducing the frictional wear between the shank portion of a ball joint and the seal covering the cavity of the joint by incorporating a wear member on the shank portion of a ball joint.

In one aspect of the present invention, a ball joint is provided for interconnecting a first member of a vehicle to a second member of a vehicle. A housing includes a cavity that is adapted to be coupled to the first member. A ball stud includes a ball end portion received in the cavity and is pivotable in the cavity. The ball stud further includes a shank portion extending from the ball end portion projecting from the cavity. The shank portion is adapted to be coupled to the second member. A tubular wear member has an inner side surface and an exterior side surface. The inner side surface is sealingly disposed on a portion of the shank portion. An annular seal includes a first end seal portion sealingly engaging the housing around the cavity and a second end seal portion for sealingly engaging the exterior side surface of the tubular wear member. The tubular wear member maintains a seal between the shank portion and the second end seal portion and reduces wear of the annular seal as the ball stud pivots within the cavity.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an illustration of a first embodiment of a ball joint according to a preferred embodiment of the present invention.

FIG. 2 is an illustration of a second embodiment of a ball joint according to the present invention.

FIG. 3 is a method for reducing wear on a ball joint according to a preferred embodiment of the present invention.

### DETAILED DESCRIPTION OF PREFERRED EMBODIMENTS

Referring now to the Drawings and particularly to FIG. 1, there is shown a ball joint, indicated generally at 10, for interconnecting at least two members of a vehicle. The ball joint 10 includes a ball stud 11 and a socket 16. The ball stud 11 includes a ball end portion 12 and a shank portion 14. The ball end portion 12 may be formed integral as one piece with the shank portion 14.

A first end 25 of the shank portion 14 is coupled to a first member 28 of a vehicle such as a control arm (not shown). The first member 28 may include an aperture for coupling the first member 28 to the shank portion 14. The first end 25 may include a threaded portion 27 whereby a fastener 29, such as a nut, is used to retain the first member 28 to the shank portion 14. Alternatively, the shank portion 14 may be coupled to the first member 28 by other means such as directly threading the first end into a threaded first member.

The socket 16 includes a cavity 18. In the preferred embodiment, the cavity 18 includes a bearing 19 for receiving the ball end portion 12 of the ball stud 11. The bearing 19 includes an inner opening 23 which is spherical shaped and dimensioned substantially similar to an outer shell surface 21 diameter of the ball end portion 12. The socket 16 is coupled to a second member 20 such as a steering knuckle or steering yoke (not shown). The socket 16 may be coupled to the second member 20 by any fastening means (e.g. bolt, weld, press fit) or may be integrally formed as one piece as part of the second member 20.

The ball joint 10 further includes an annular seal 22. Preferably, the annular seal 22 is made from an elastomeric material which adapts to the expansion and contraction of the ball joint 10 as the ball end portion 12 pivots within the socket 16. Alternatively, the annular seal 22 may be made from any other suitable material. The annular seal 22 maintains a seal over the cavity 18 and ball end portion 12. The annular seal 22 encapsulates the interconnection of the cavity 18 and ball end portion 12 for maintaining a lubricant (not shown) within the seal 22 and for preventing dirt and other contaminants from entering the ball joint 10, to prevent premature wear of the ball joint 10.

The annular seal 22 extends from the socket 16 to a generally tubular wear reducing member 24 disposed on an intermediate section 15 of the shank portion 14. To accomplish this, the annular seal 22 includes a first end seal portion 36 and a second end seal portion 34. In the preferred embodiment, the first end seal portion 36 is disposed in an annular recess 37 of the socket 16. The second end seal portion 34 engages an exterior side surface 32 of the tubular wear reducing member 24. Alternatively, the first end seal portion 36 can be secured to the socket 16 by other means if so desired.

In the preferred embodiment, the tubular wear reducing member 24 includes a tube-like polyolefin member such as a heat shrink tubing TAT-125 manufactured by Raychem. The TAT-125 heat shrink tubing is a flexible thin wall polyolefin material that has 2:1 heat shrink capabilities. The tubular wear reducing member 24 is flexible such that its inner side surface 30 will conform to and seal against the underlying surface to which it is disposed on regardless of the shape, contour, bend, or change in pitch of the underlying surface. The polyolefin based material provides a smooth outer contact surface which is significantly less abrasive than an outer surface 17 of the intermediate section 15 of the shank portion 14 which is typically made of metal. As a result, premature wear of the second end seal portion 34 of the annular seal 22 is significantly reduced as the second end seal portion 34 is repetitiously displaced over the exterior surface 32 of the tubular wear reducing member 24. The tubular wear reducing member 24 may be selected to accommodate the range of movement of the second end seal portion 34 as it extends across the intermediate section 15 of the shank portion 14.

To permanently affix the tubular wear reducing member 24 to the intermediate section 15 of the shank portion 14, the tubular wear reducing member 24 is disposed around the intermediate section 15 at a predetermined location therealong. The ball stud 11 is then heated by a suitable heating device, such as an oven. Alternatively, any type of heating device (e.g., hot lamps or forced hot air) can be used to affix the tubular wear element 24 to the intermediate section 15 of the shank portion 14. The tubular wear reducing member 24 and the intermediate section 15 are exposed to the heating device for a sufficient duration of time to allow the tubular wear reducing member 24 to shrink and conform to the underlying surface area of the intermediate section 15 of the shank portion 14. Alternatively, an adhesive 38 may used to affix the tubular wear reducing member 24 to the shank portion 14. To accomplish this, the adhesive can be applied to the inner surface 30 of the tubular wear reducing member 24 or to the outer surface of the shank portion 14 for bonding the tubular wear reducing member 24 to an outer surface of the intermediate section 15 of the shank portion 14. The adhesive 38 can be used solely to affix the tubular wear reducing member 24 to the shank portion 14 or can be used in combination with the heating device to affix the tubular wear reducing member 24 to the shank portion 14.

Alternatively, the tubular wear reducing member 24 may include an elastomeric material that has expansion and contraction properties for insertion and placement over the contacting area of the shank portion 14 required to reduce wear of the second end seal portion 34 of the annular seal 22. Preferably, the elastomeric wear reducing member 24 is retained to the intermediate section 15 of the shank portion 14 as it contracts about the exterior surface 17. However, adhesive 38 may be used to adhere the elastomeric wear reducing member 24 to the exterior surface 17 of the intermediate section 15.

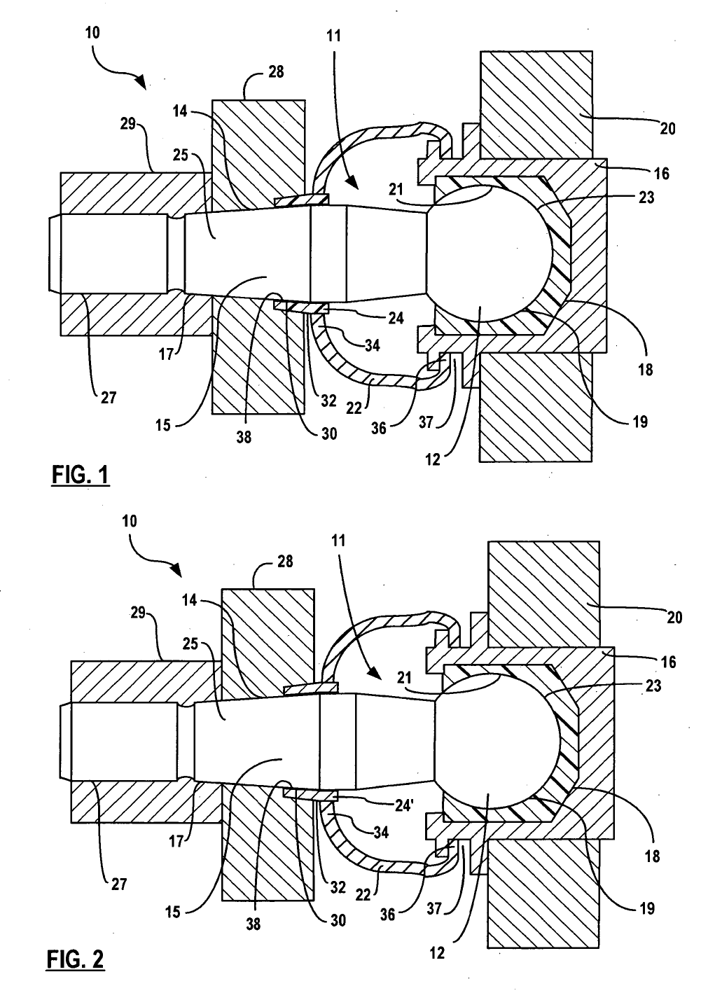

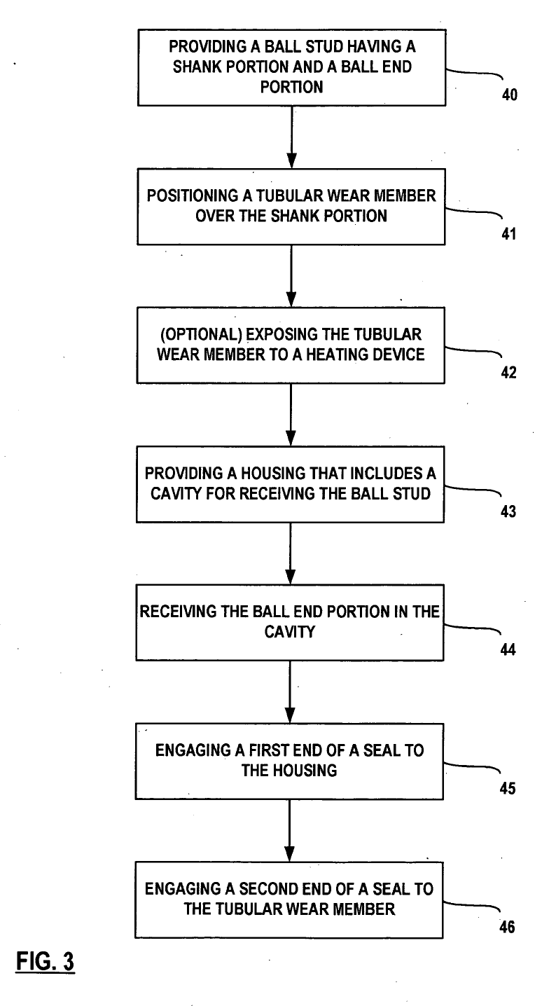

FIG. 2 illustrates another preferred embodiment of the present invention. The tubular wear reducing member 24′ may include a metallic tube such as a oil impregnated bushing that is capable of being press-fit over the shank portion 14. The oil impregnated metallic tube may provide lubrication when in contact with the second end seal portion 34 of the annular seal 22. Alternatively, the tubular wear member 24′ may include a plastic composite bushing. The plastic composite may be press fit or adhered to the shank portion 14. The plastic composite would provide a lower coefficient of friction than that of the metal or metallic composition of the shank portion 14 which would reduce the premature wear of the second end seal portion 34 of the annular seal 22

The tubular wear reducing member 24 for each embodiment of the present invention can be used in conjunction with any of the ball joint assemblies shown in U.S. Pat. No. 5,066,159 to Urbach, U.S. Pat. No. 5,380,114 to Urbach, U.S. Pat. No. 5,678,947 to Urbach et. al., U.S. Pat. No. 5,931,597 to Urbach, and U.S. Pat. No. 6,042,294 to Urbach, the disclosures of each of these patents incorporated by reference in entirety herein.

FIG. 3 illustrates a method for preventing wear of a seal covering a ball joint according to the preferred embodiment of the present invention illustrated in FIG. 1. In step 40, a ball stud 11 is provided that includes a ball end portion 12 and a shank portion 14. In step 41, a tubular wear reducing member 24 is disposed over the shank portion 14 of the ball stud 12. The tubular wear reducing member 24 is manufactured to a predetermined length for covering a predetermined contact area of the shank portion 14. Optionally, step 42 may be performed if the wear reducing member 24 requires shrinkage for conforming to exterior surface 17 of the shank portion 12. In step 42, the ball stud 11 and wear reducing member 24 are exposed to a heating device for shrinking and adhering the tubular wear reducing member 24 about the exterior surface 17 of the shank portion 14. In step 43, a socket 16 including a cavity 18 is provided for receiving the ball stud 11. In step 44, the ball end portion 12 of the ball stud 11 is received in the cavity 18 of the socket 16. In step 45, the first end seal portion 36 of the annular seal 22 is disposed in the inner opening 23 of the socket 16. In step 46, the second end seal portion 34 of the annular seal 22 engages the tubular wear reducing member 24 disposed on the exterior surface of the intermediate section 15 of the shank portion 14.

The tubular wear reducing member may be used on any other circular sealing surface in the vehicle that has relative motion. Such examples include outer tie rods and inner tie rods.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A ball joint for connecting a first member of a vehicle to a second member of a vehicle, the ball joint comprising:
a housing including a cavity, said housing adapted to be coupled to the first member;
a ball stud including a ball end portion received in said cavity and being pivotable in said cavity, said ball stud further including a shank portion extending from said ball end portion projecting from said socket, said shank portion adapted to be coupled to said second member;
a wear reducing member disposed about a portion of said shank portion, said wear reducing member having an inner side surface and an exterior side surface, said inner side surface sealingly disposed on a portion of said shank portion; and
an annular seal including a first end seal portion sealingly engaging said housing and a second end seal portion sealingly engaging said exterior side surface of said wear reducing member wherein said wear reducing member maintains a seal between said shank portion and said second end seal portion and reduces wear of said second end seal portion of said annular seal as said ball stud pivots within said cavity.

2. The ball joint of claim 1 wherein said tubular wear member includes heat shrink tubing.

3. The ball joint of claim 1 wherein said tubular wear member includes press fit tubing.

4. The ball joint of claim 1 wherein said tubular wear member is adhered to said shank portion.

5. The ball joint of claim 1 wherein said tubular wear member comprises an elastomeric material.

6. A method for producing a reduced wear ball joint seal for use in a vehicle, the method comprising the steps of:
providing a ball stud having a ball end portion and a shank portion;
adapting a tubular wear member to said shank portion;
providing a housing including a cavity;
receiving a ball end portion of said ball stud in said cavity;
engaging a first end of said seal to said housing; and
engaging a second end of said seal to said tubular wear member.

7. The method of claim 6 wherein said step of adapting said tubular member to said shank portion comprises the steps of:
(a) positioning said tubular wear member over an intermediate section of said shank portion; and
(b) exposing said tubular wear member to a heating device for shrinking said tubular wear member on said intermediate section of said shank portion.

8. The method of claim 7 wherein said step of exposing said tubular wear member to a heating device includes exposing said tubular wear member to an oven.

9. The method of claim 7 wherein said step of exposing said tubular wear member to a heating device includes exposing said tubular wear member to heat lamps.

10. The method of claim 7 wherein said step of exposing said tubular wear member to a heating device includes exposing said tubular wear member to forced hot air.

11. The method of claim 7 wherein said tubular wear member includes an adhesive liner for adhering said tubular wear member to said shank portion.

12. The method of claim 6 wherein said step of adapting said tubular wear member to said shank portion includes press fitting said tubular wear member over said shank portion.

13. The method of claim 6 wherein said tubular wear member is elastomeric and said step of adapting said tubular wear member to said shank portion comprises the steps of:
(a) expanding said tubular wear member;
(b) positioning said tubular wear member about said shank portion; and
(c) retracting said tubular wear member for sealingly engaging said shank portion.
